(19) United States
(12) Patent Application Publication
(10) Pub. No.: US 2016/0337910 A1
(43) Pub. Date: Nov. 17, 2016

(54) METHOD FOR SENDING INFORMATION REGARDING A SECONDARY CELL VIA A GROUP MESSAGE IN A PRIMARY CELL

(71) Applicant: TELEFONAKTIEBOLAGET LM ERICSSON (PUBL), Stockholm (SE)

(72) Inventors: Peter WERNER, Linköping (SE); Stefan JOHANSSON, Linköping (SE); Paul SCHLIWA-BERTLING, Ljungsbro (SE)

(73) Assignee: TELEFONAKTIEBOLAGET LM ERICSSON (PUBL), Stockholm (SE)

(21) Appl. No.: 15/106,220

(22) PCT Filed: Dec. 19, 2013
(86) PCT No.: PCT/SE2013/051577

§ 371 Date: Jun. 17, 2016

(51) Int. Cl. H04W 36/00; H04W 72/04; H04W 36/04; H04L 12/18

(52) U.S. Cl. CPC H04W 36/0061; H04L 12/189; H04W 72/04; H04W 36/04

(57) ABSTRACT

A method in a network node for sending a message to a first group of wireless devices. The first group of wireless devices is served by a Primary Cell. The network node and the first group of wireless devices operate in a wireless communications network. The network node sends a single message to the first group of wireless devices. The wireless devices in the first group of wireless devices are in carrier aggregation mode, being further served by a Secondary Cell, SCell, of the network node. The single message comprises a first common Radio Network Temporary Identifier addressing all the wireless devices in the first group of wireless devices. The single message further comprises information related to the SCell.

### TECHNICAL FIELD

The present disclosure relates generally to a network node and methods therein for sending a message to a first group of wireless devices comprising a wireless device. The present disclosure also relates to the wireless device, and methods therein for receiving the message from the network node, and computer programs and computer-readable storage mediums, having stored thereon the computer programs to carry out these methods performed by the network node and the wireless device.

### BACKGROUND

Communication devices such as terminals are also known as e.g. User Equipments (UE), wireless devices, mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

LTE

The LTE system architecture is shown in FIG. 1. In LTE, the DL radio interface is based on Orthogonal Frequency Division Multiplexing (OFDM), while the UL is based on a single carrier modulation method known as Discrete Fourier Transform Spread OFDM (DFT-S-OFDM), see 3GPP TR 36.300v11.7.0 sub-clause 5, Evolved Universal Terrestrial Radio Access (E-UTRA) and Evolved Universal Terrestrial Radio Access (E-UTRAN); Medium Access Control (MAC) protocol specification.

The logical interfaces between eNBs, i.e., X2, and between an eNB and a Mobility Management Entity/Serving GateWay (MME/S-GW), i.e., S1, in the LTE architecture are shown in FIG. 1. The E-UTRAN comprises eNBs, providing the E-UTRA user plane Packet Data Convergence Protocol (PDCP)/Radio Link Control (RLC)/Medium Access Control (MAC)/Physical Layer (PHY) and control plane, i.e., Radio Resource Control (RRC) over PDCP/RLC/MAC/PHY protocol terminations towards the UE. The eNBs may be interconnected with each other by means of the X2 interface. The eNBs are connected by means of the S1 interface to the Evolved Packet Core (EPC), more specifically to the MME, by means of the S1-MME and to the S-GW by means of the S1-U interface. The S1 interface supports a many-to-many relation between MMES/S-GWs and eNBs.

The split of functions between eNB and EPC is described in the specifications 3GPP TS 23.401 v11.7.0, General Packet Radio Service (GPRS) enhancements for E-UTRAN access, 3GPP TS 36.300 v11.7.0 E-UTRA and E-UTRAN; Overall description; Stage 2, and 3GPP TS 36.401 v11.2.0 E-UTRAN; Architecture description.

The architecture defined using E-UTRAN may be further described as follows:
The E-UTRAN comprises a set of eNBs connected to the EPC through the S1 interface.
An eNB may support a Frequency Division Duplex (FDD) mode, a Time Domain Duplex (TDD) mode or a dual mode operation.

It may be noted that embodiments herein may be applied to other types of networks and standards, e.g., GSM and UTRAN. E-UTRAN is used merely as an exemplifying standard to illustrate embodiments herein.

Carrier Aggregation (CA)

The CA feature requires that the eNB controls at least two Rel-8 cells on different frequencies to thereby achieve increased transmission bandwidth. FIG. 2 illustrates an example of such an eNB, with cells on two different frequencies. The solid black arrows represent the 2 UL component carriers and the white arrows represent the 2 DL component carriers.

CA capable UEs may, according to 3GPP Rel-10 be configured via RRC to aggregate up to 5 DL carriers and 5 UL carriers.

UEs not configured for CA, e.g., rel. 8 UEs, do not see any difference compared to baseline. FIG. 3a and FIG. 3b illustrate examples UE configurations supported by the CA feature. Each of the figures shows a network node on the left, and a UE on the right. The network node has two cells, on two different frequencies. The arrows represent the Component Carriers (CCs), two DL, and two UL. FIG. 3a illustrates a case with asymmetric 2 DL, 1 UL CA. The dotted black arrows represent the 2 DL Component Carriers (CCs), the striped arrow represents the 1 UL CC, and the white arrow represents 1 UL CC not being used by the UE. FIG. 3b illustrates a case with a legacy UE. The dotted black arrow represents 1 DL CC being used by the UE, the striped arrow represents 1 UL being used by the UE and the white arrows represent 1 UL CC and 1 DL CC not being used by the UE.

Types of CA

There are several types of CA. In contiguous intra band CA, all the carriers are adjacent to each other, in the same band. In non-contiguous intra-band CA, all the carriers are in the same operating band, but an uncoordinated service, from another operator, exists in the in the gap between the carriers. In inter-band CA, each operating band has one carrier. FIG. 4 illustrates an example of contiguous intra band CA. FIG. 5 illustrates an example of non-contiguous intra band CA. FIG. 6 illustrates inter-band CA.

A component carrier is a 3GPP release-8 LTE carrier of 1.4, 3, 5, 10, 15 and 20 MHz channel bandwidth.

CA Protocol Impact

Secondary cells should be considered as extra resources for the UE. Thus, when a UE is configured with CA, it may still have only one RRC connection per UE; and any configured Signalling Radio Bearer (SRB) and Data Radio Bearers (DRBs) are also still one per UE. Furthermore, only the PCell is monitored for system information. The split over different carriers is made on the MAC layer and below, see FIG. 7. FIG. 7 is a graphical representation of a protocol structure according to 3GPP Rel-10.

SCell Configuration

To enable the UE to use CA, the eNB may configure the UE with the SCell, and then activate it. The SCell may, from the perspective of the UE, either consist of both a DL and an UL, or only a DL carrier component. Even if the UE is only using the DL of the cell it is using as an SCell, from the eNB perspective, the cell will have both an UL and a DL. Other UEs may consider the same cell, seen from an eNB perspective, as their PCell.

The SCell is configured using RRC Connection Reconfiguration procedure. It is possible to configure multiple SCells for the same UE in the same RRC message, and it is also possible to configure and deconfigure SCells in the same message.

### SUMMARY

It is an object of embodiments herein to improve the performance in a wireless communications network using CA.

According to a first aspect of embodiments herein, the object is achieved by a method in a network node for sending a message to a first group of wireless devices. The first group of wireless devices is served by a Primary Cell, PCell of the network node. The network node and the first group of wireless devices operate in a wireless communications network. The network node sends a single message to the first group of wireless devices. The wireless devices in the first group of wireless devices are in CA mode, being further served by a Secondary Cell, SCell, of the network node. The single message comprises a first common Radio Network Temporary Identifier, RNTI, addressing all the wireless devices in the first group of wireless devices. The single message further comprises information related to the SCell.

According to a second aspect of embodiments herein, the object is achieved by a method in the wireless device in the first group of wireless devices for receiving the message from the network node. The first group of wireless devices is served by the PCell of the network node. The network node, the wireless device, and the first group of wireless devices operate in the wireless communications network. The wireless device receives the single message from the network node. The single message is addressed to the first group of wireless devices. The wireless device and the wireless devices in the first group of wireless devices are in CA mode, being further served by the SCell of the network node. The single message comprises the first common RNTI addressing all the wireless devices in the first group of wireless devices. The single message further comprises information related to the SCell.

According to a third aspect of embodiments herein, the object is achieved by the network node for sending the message to the first group of wireless devices. The first group of wireless devices are configured to be served by the PCell of the network node. The network node and the first group of wireless devices are configured to operate in the wireless communications network. The network node is configured to send the single message to the first group of wireless devices. The wireless devices in the first group of wireless devices are configured to be in CA mode, being further served by the SCell of the network node. The single message comprises the first common RNTI, configured to address all the wireless devices in the first group of wireless devices. The single message further comprises information related to the SCell.

According to a fourth aspect of embodiments herein, the object is achieved by the wireless device for receiving the message from the network node. The wireless device is configured to be in the first group of wireless devices. The first group of wireless devices is served by the PCell of the network node. The network node, the wireless device, and the first group of wireless devices are configured to operate in the wireless communications network. The wireless device is configured to receive the single message from the network node, the single message being configured to address the first group of wireless devices. The wireless device and the wireless devices in the first group of wireless devices are configured to be in CA mode, being further served by the SCell of the network node. The single message comprises the first common RNTI configured to address all the wireless devices in the first group of wireless devices. The single message further comprises information related to the SCell.

According to a fifth aspect of embodiments herein, the object is achieved by a computer program, comprising instructions which, when executed on at least one processor, cause the at least one processor to carry out the method performed by the network node.

According to a sixth aspect of embodiments herein, the object is achieved by a computer-readable storage medium, having stored thereon the computer program, comprising instructions which, when executed on at least one processor, cause the at least one processor to carry out the method performed by the network node.

According to a seventh aspect of embodiments herein, the object is achieved by a computer program, comprising instructions which, when executed on at least one processor, cause the at least one processor to carry out the method performed by the wireless device.

According to an eighth aspect of embodiments herein, the object is achieved by a computer-readable storage medium, having stored thereon the computer program, comprising instructions which, when executed on at least one processor, cause the at least one processor to carry out the method performed by the wireless device.

By sending the single message to the first group of wireless devices, comprising the first common RNTI addressing all the wireless devices in the first group of wireless devices, the network node may send the information related to the SCell to only those wireless devices served by the network node that are in CA mode, without needing to send this information to each wireless device in the first group of wireless devices individually. Hence, UE power consumption is decreased, as only those wireless devices that may need the information related to the SCell, i.e., those wireless devices served by the network node that are in CA mode, may with the approach herein obtain and read the information. Further advantages of some embodiments disclosed herein are discussed further down below.

### BRIEF DESCRIPTION OF THE DRAWINGS

Examples of embodiments herein are described in more detail with reference to the accompanying drawings, in which:

FIG. 1 is a schematic diagram illustrating an LTE architecture showing logical interfaces between eNBs, i.e., X2, and between an eNB and MME/S-GW, i.e., S1.

FIG. 2 is a schematic diagram illustrating an eNB with cells on two different frequencies.

FIG. 3a is a schematic diagram illustrating a UE configuration supported by the CA feature.

FIG. 3b is a schematic diagram illustrating a UE configuration supported by the CA feature.

FIG. 4 is a schematic diagram illustrating contiguous intra band CA.

FIG. 5 is a schematic diagram illustrating non-contiguous intra band CA.

FIG. 6 is a schematic diagram illustrating inter band CA.

FIG. 7 is a schematic diagram illustrating a protocol structure according to 3GPP Rel-10.

FIG. 8 is a schematic block diagram illustrating embodiments in a wireless communications network, according to some embodiments.

FIG. 9 is a flowchart illustrating embodiments of a method in a network node, according to some embodiments.

FIG. 10 is a flowchart illustrating embodiments of a method in a wireless device, according to some embodiments.

FIG. 11 is a block diagram of a network node that is configured according to some embodiments.

FIG. 12 is a block diagram of a wireless device that is configured according to some embodiments.

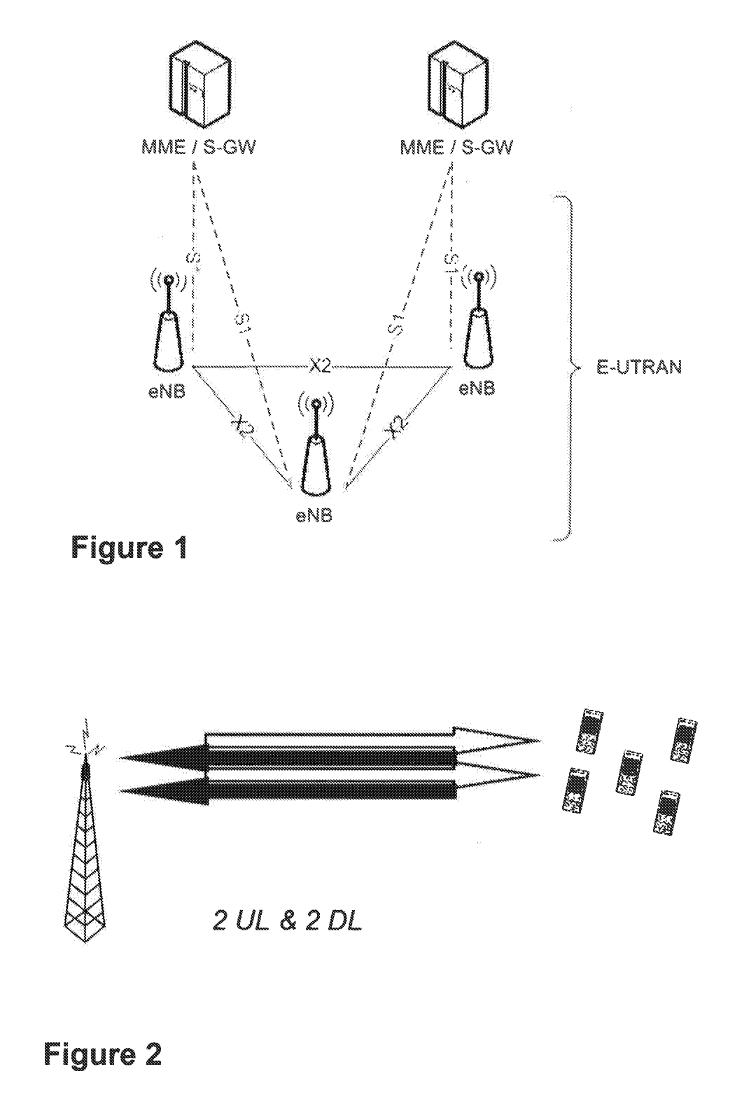

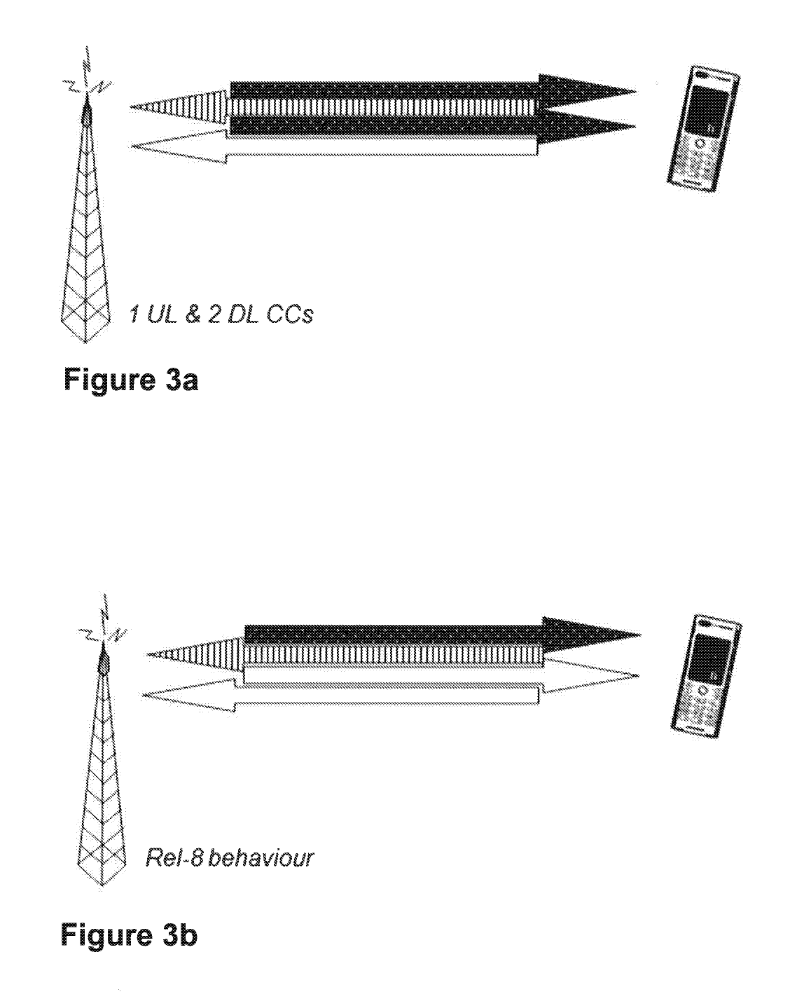

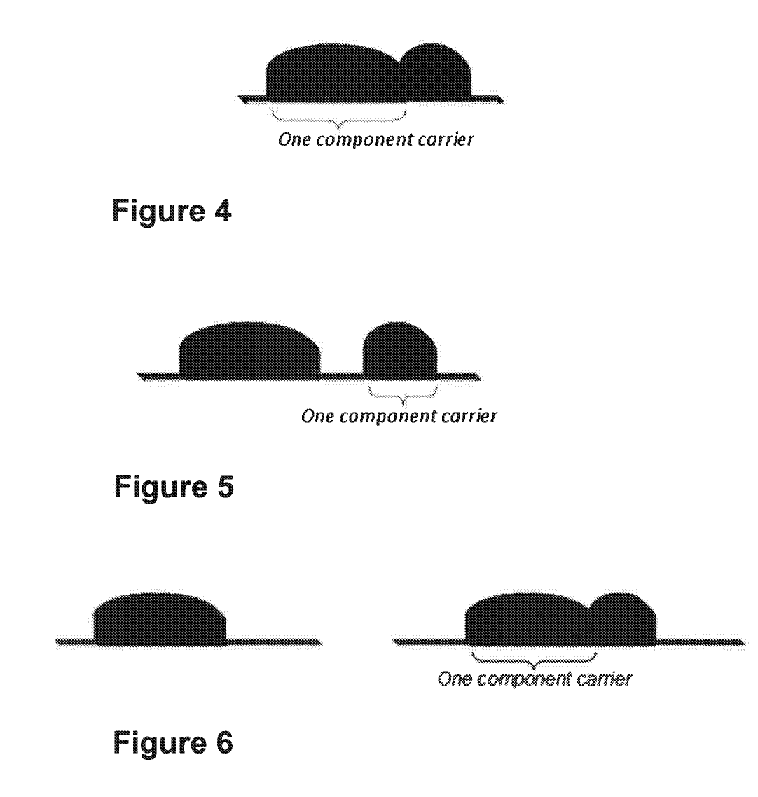

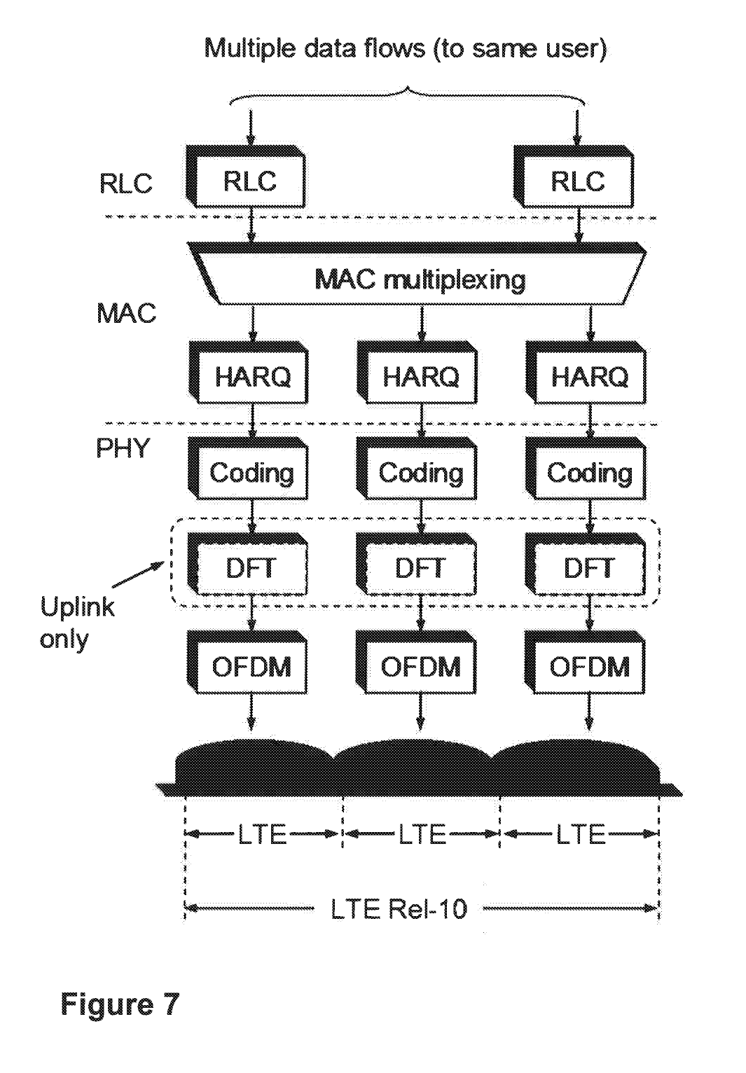

### DETAILED DESCRIPTION

As part of the solution according to embodiments herein, one or more problems that may be associated with use of at least some of the prior art solutions will first be identified and discussed.

A UE in CA mode receives data in the PCell and the SCell.

Since the UE does not read System Information in the SCell, it has to be informed about important changes in the SCell by other means, e.g. RRC Connection Reconfiguration procedure. Multimedia Broadcast and Multicast Service (MBMS) area activation/deactivation resulting in the change of the unicast subframe configuration is one example for such a RRC configuration change in a SCell that may be critical for the UE to be informed about.

However, if there are numerous UEs in CA mode, then this approach requires numerous RRC Connection Reconfiguration messages to be sent to each UE. Furthermore, this message may contain the same information for each UE, e.g. the changed unicast subframe configuration in the SCell, and thus result in inefficient resource utilization on the radio interface as well as processing capacity in the eNB. Broadcasting those changes in System Information is not a good solution either because it requires frequent updates of the system information, and thus, also frequent acquisition of the system information by all UEs served or camping on that cell which may significantly impact the UE battery lifetime.

Embodiments will now be described more fully hereinafter with reference to the accompanying drawings, in which examples of the claimed subject matter are shown. The claimed subject matter may, however, be embodied in many different forms and should not be construed as limited to the embodiments set forth herein. Rather, these embodiments are provided so that this disclosure will be thorough and complete, and will fully convey the scope of the claimed subject matter to those skilled in the art. It should also be noted that these embodiments are not mutually exclusive. Components from one embodiment may be tacitly assumed to be present/used in another embodiment.

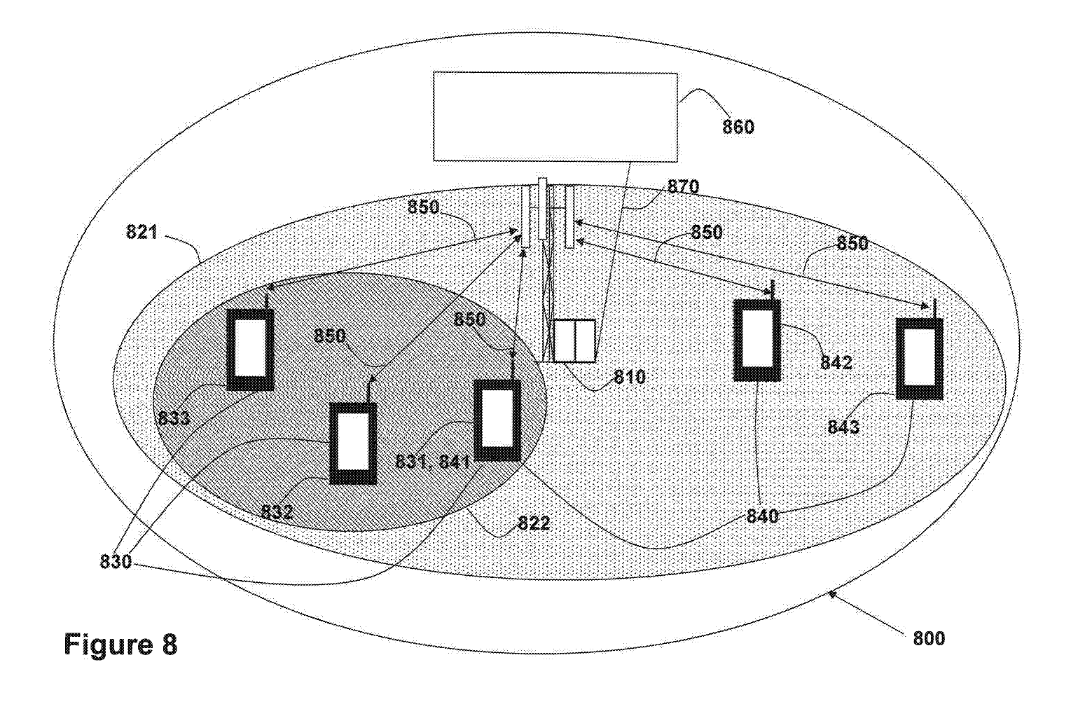

FIG. 8 depicts a wireless communications network 800 in which embodiments herein may be implemented. The wireless communications network 800 may for example be a network such as a Long-Term Evolution (LTE), e.g. LTE Frequency Division Duplex (FDD), LTE Time Division Duplex (TDD), LTE Half-Duplex Frequency Division Duplex (HD-FDD), Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Worldwide Interoperability for Microwave Access (WiMax), or any cellular network or system.

The wireless communications network 800 comprises a network node 810. The network node 810 may be, for example, a base station such as e.g. an eNB, eNodeB, or a Home Node B, a Home eNode B, femto Base Station, BS, pico BS or any other network unit capable to serve a device or a machine type communication device in the wireless communications network 800. In some particular embodiments, the network node 810 may be a stationary relay node or a mobile relay node. The wireless communications network 800 covers a geographical area which is divided into cell areas, wherein each cell area is served by a network node, such as network node 810, although, one network n may serve one or several cells. When CA is used, a network node may have a number of serving cells, one for each component carrier. Coverage of the serving cells may differ, due to, e.g., component carrier frequencies. The RRC connection is handled by one cell, the Primary serving cell, or Primary Cell (PCell), served by a Primary Component Carrier (PCC), i.e., DL and UL PCC. The other component carriers are all referred to as Secondary Component Carrier (SCC), i.e., DL and possibly UL SCC, serving the Secondary serving cells or Secondary Cells (SCells). In the example depicted in FIG. 8, the network node 810 serves a Primary Cell (PCell) 821 and a Secondary Cell (SCell) 822. The network node 810 may be of different classes, such as e.g. macro eNodeB, home eNodeB or pico base station, based on transmission power and thereby also cell size. Typically, wireless communications network 800 may comprise more cells similar to the first cell 821 and the second cell 822, served by their respective network nodes. This is not depicted in FIG. 8 for the sake of simplicity. The network node 810 may support one or several communication technologies, and its name may depend on the technology and terminology used. In 3GPP LTE network entities, which may be referred to as eNodeBs or even eNBs, may be directly connected to one or more core networks.

A number of wireless devices are located in the wireless communications network 800. In the example scenario of FIG. 8, the wireless communications network 800 comprises a first group 830 of wireless devices 831, 832, 833. The wireless device 831 may be used herein to illustrate some examples, unless otherwise noted, and may thus be referred to herein as a “wireless device 830” or “the wireless device 830”. In some embodiments, the wireless communications network 800 may comprise a second group 840 of wireless devices 841, 842, 843. Each of the wireless devices in the first group 830 of wireless devices 831, 832, 833 and in the second group 840 of wireless devices 841, 842, 843 may e.g. communicate with the network node 810 over a respective radio link 850.

Each of the wireless devices in the first group 830 of wireless devices 831, 832, 833 and in the second group 840 of wireless devices 841, 842, 843 is a wireless communication device such as a UE, which is also known as e.g. mobile terminal, wireless terminal and/or mobile station. Each of the wireless devices in the first group 830 of wireless devices 831, 832, 833 and in the second group 840 of wireless devices 841, 842, 843 is wireless, i.e., it is enabled to communicate wirelessly in the wireless communication network 800, sometimes also referred to as a cellular radio system or cellular network. The communication may be performed e.g., between two devices, between a device and a regular telephone and/or between a device and a server. The communication may be performed e.g., via a RAN and possibly one or more core networks, comprised within the wireless communication network 800.

Each of the wireless devices in the first group 830 of wireless devices 831, 832, 833 and in the second group 840 of wireless devices 841, 842, 843 may further be referred to as a mobile telephone, cellular telephone, or laptop with wireless capability, just to mention some further examples. Each of the wireless devices in the first group 830 of wireless devices 831, 832, 833 and in the second group 840 of wireless devices 841, 842, 843 may be, for example, portable, pocket-storable, hand-held, computer-comprised, or vehicle-mounted mobile devices, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) devices, devices equipped with a wireless interface, such as a printer or a file storage device or any other radio network unit capable of communicating over a radio link in a cellular communications system such as wireless communication network 800.

The wireless communication network 800 may also comprise a core network node 860. The core network node 860 may be, for example, a “centralized network management node” or “coordinating node”, which, as used herein, is a core network node, which coordinates radio resources with one or more network nodes, such as the network node 810, and/or one or more wireless devices, such as e.g., wireless device 831. Some examples of the coordinating node are network monitoring and configuration node, Operations Support System (OSS) node, Operations & Maintenance (O&M) node, Minimization of Drive Tests (MDT) node, Self-Organizing Network (SON) node, positioning node, a gateway node such as Packet Data Network Gateway (P-GW), Mobility Management Entity (MME), or S-GW network node or femto gateway node, a macro node coordinating smaller radio nodes associated with it, etc. . . . . The core network node 860 may e.g. communicate with the network node 810 over a link 870.

According to embodiments herein, which will be further described below in reference to particular actions, it may be possible for the network, e.g., the network node 810, to distribute information related to a SCell, such as SCell 822, to wireless devices, e.g., UEs, that are in CA mode such as the wireless devices 831, 832, 833 in the first group 830 of wireless devices 831, 832, 833, in a single message rather, than sending the same message to each wireless device, e.g., UE, 831, 832, 833, wasting bandwidth, and consuming processing resources in the network node, e.g., eNB, 810. This new message distribution method may be achieved by introducing a new RNTI value, e.g., a CA-RNTI, which may be read by all wireless devices, i.e., UEs, in CA mode, such as the wireless devices 831, 832, 833 in the first group 830 of wireless devices 831, 832, 833. Thus, information that could be sent to each wireless device 831, 832, 833, e.g., UE, in RRC Connection Reconfiguration using the C-RNTI, may instead be sent once with the CA-RNTI, which is then read by all CA wireless devices, e.g., UEs, such as the wireless devices 831, 832, 833 in the first group 830 of wireless devices 831, 832, 833.

Embodiments herein introduce a new RNTI to be added to the existing RNTIs, which are depicted in Table 1 and Table 2 below. The new RNTI, for which a suggested name is “CA-RNTI”, addresses all wireless devices in CA mode, such as the wireless devices 831, 832, 833 in the first group 830 of wireless devices 831, 832, 833. All wireless devices is CA mode, such as the wireless devices 831, 832, 833 in the first group 830 of wireless devices 831, 832, 833, may then read at once the content of this message.

Thus, it may be necessary to introduce a new message type in the RRC protocol, see 3GPP TR 36.331 v11.5.0, E-UTRA and E-UTRAN; RRC protocol specification, that is addressed by the new CA-RNTI. Alternatively, it may be necessary to adapt the existing message RRC Connection Reconfiguration so that it may be used with a non-wireless device specific RNTI, i.e. the new CA-RNTI.

TABLE 1
Range of values which is allocated for each RNTI types
according to Table 7.1-1 in 3GPP 36.321 v.11.4.0.

| Value | |
|---|---|
| (hexa- | |
| decimal) | RNTI |
| 0000 | N/A |
| 0001-003C | RA-RNTI, C-RNTI, Semi-Persistent Scheduling C-RNTI, |
| | Temporary C-RNTI, TPC-PUCCH-RNTI and |
| | TPC-PUSCH-RNTI (see note) |
| 003D-FFF3 | C-RNTI, Semi-Persistent Scheduling C-RNTI, Temporary |
| | C-RNTI, TPC-PUCCH-RNTI and TPC-PUSCH-RNTI |
| FFF4-FFFC | Reserved for future use |
| FFFD | M-RNTI |
| FFFE | P-RNTI |
| FFFF | SI-RNTI |

TABLE 2
Types of RNTIs and their usage according to Table 7.1-2 in 3GPP 36.321 v.11.4.0.

| RNTI | Usage | Transport Channel | Logical Channel |
|---|---|---|---|
| P-RNTI | Paging and System Information change | PCH | PCCH |
| | notification | | |
| SI-RNTI | Broadcast of System Information | DL-SCH | BCCH |
| M-RNTI | MCCH Information change notification | N/A | N/A |
| RA-RNTI | Random Access Response | DL-SCH | N/A |
| Temporary C-RNTI | Contention Resolution | DL-SCH | CCCH |
| | (when no valid C-RNTI is available) | | |
| Temporary C-RNTI | Msg3 transmission | UL-SCH | CCCH, DCCH, DTCH |
| C-RNTI | Dynamically scheduled unicast transmission | UL-SCH | DCCH, DTCH |
| C-RNTI | Dynamically scheduled unicast transmission | DL-SCH | CCCH, DCCH, DTCH |
| C-RNTI | Triggering of PDCCH ordered random access | N/A | N/A |
| Semi-Persistent | Semi-Persistently scheduled unicast | DL-SCH, UL-SCH | DCCH, DTCH |
| Scheduling C-RNTI | transmission (activation, reactivation and retransmission) | | |
| Semi-Persistent | Semi-Persistently scheduled unicast | N/A | N/A |
| Scheduling C-RNTI | transmission (deactivation) | | |
| TPC-PUCCH-RNTI | Physical layer Uplink power control | N/A | N/A |
| TPC-PUSCH-RNTI | Physical layer Uplink power control | N/A | N/A |

Yet in another alternative, a new generic Distribution-RNTI (D-RNTI) may be introduced that may be used for all cases where a specific message may need to be distributed to a group of wireless devices engaged in some specific configuration.

Such D-RNTI may be combined with a new configuration, or service, specific identifier, e.g., Configuration RNTI (Conf-RNTI), that may be used to address some specific use case, e.g., a configuration identifier indicating the case of CA, as discussed herein. Hence, a combination of D-RNTI+CA-RNTI may be used to address a message that shall be received and processed by a group of wireless devices in CA mode, such as the wireless devices 831, 832, 833 in the first group 830 of wireless devices 831, 832, 833.

It may be assumed that the message contents being distributed using the new method described herein does not need to be encrypted, as it may provide similar information as being broadcast in the System Information.

Potential evolution of this new approach, whereby sensitive message contents may be sent, may need new security measures that may enable a group of wireless devices in connected mode to use potentially the same shared secret with the network that may ensure a secure message delivery.

Embodiments herein introduce a mechanism to address, by means of a new RNTI called the “CA-RNTI” or alternatively a combination of a distribution RNTI “D-RNTI” combined with a configuration/service RNTI, multiple wireless devices, such as the wireless devices 831, 832, 833 in the first group 830 of wireless devices 831, 832, 833, that are interested in the same CA related configuration information with one message, instead of sending this information to each wireless device, such as the wireless devices 831, 832, 833 in the first group 830 of wireless devices 831, 832, 833, with the C-RNTI.

Thus, embodiments herein may significantly reduce RRC signaling load in PCells that are configured for CA, such as PCell 821.

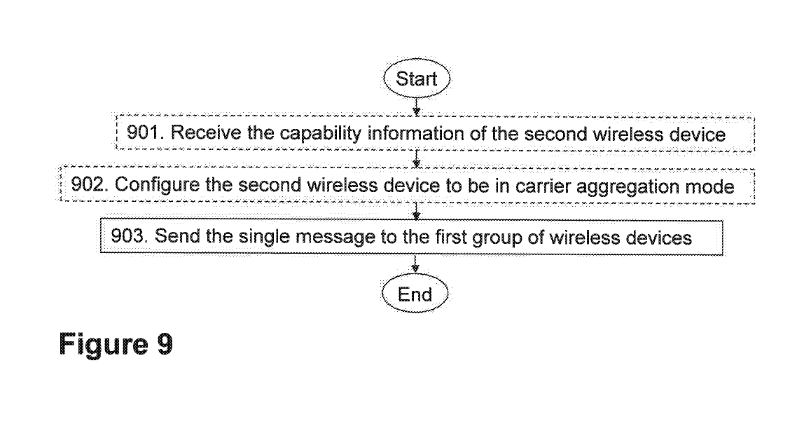

Embodiments of a method performed by the network node 810 for sending a message to the first group 830 of wireless devices 831, 832, 833, will now be described with reference to the flowchart depicted in FIG. 9. The first group 830 of wireless devices 831, 832, 833 is served by the Primary Cell, PCell, 821 of the network node 810. The network node 810 and the first group 830 of wireless devices 831, 832, 833 operate in the wireless communications network 800. FIG. 9 depicts a flowchart of the actions that are or may be performed by the network node 810 in embodiments herein. A continuous line depicts a mandatory action. Discontinued lines depict optional actions.

The method may comprise the following actions, which actions may as well be carried out in another suitable order than that described below. In some embodiments, all the actions may be carried out, whereas in other embodiments only some action/s may be carried out.

Action 901

The network node 810 may receive, from at least one wireless device 831, 832, 833 in the first group 830 of wireless devices 831, 832, 833, capability information of the at least wireless device 831, 832, 833, the capability information comprising at least one of: capability to be in CA mode and capability to process CA-RNTI information.

In other embodiments, the network node 810 may receive the capability information from at least another wireless device 831, 832, 833 in the first group 830 of wireless devices 831, 832, 833. In some embodiments, the another wireless device 831, 832, 833 may be referred to as a second wireless device 831, 832, 833. Thus, in these embodiments, the network node 810 may receive, from at least the second wireless device 831, 832, 833 in the first group 830 of wireless devices 831, 832, 833, the capability information of the at least second wireless device 831, 832, 833.

In some embodiments, this may be implemented by receiving a UECapabilitylnformation message from the at least one wireless device 831, 832, 833 in the first group 830 of wireless devices 831, 832, 833, or the at least second wireless device 831, 832, 833.

This is an optional action.

Action 902

The network node 810 may configure the at least one wireless device 831, 832, 833 in the first group 830 of wireless devices 831, 832, 833 to be in CA mode. This is an optional action. In the embodiments wherein the network node 810 receives the capability information from at least the second wireless device 831, 832, 833 in the first group 830 of wireless devices 831, 832, 833, the network node 810 may configure the at least second wireless device 831, 832, 833 in the first group 830 of wireless devices 831, 832, 833 to be in CA mode.

In some embodiments, this may be implemented by sending a RRCConnectionReconfiguration message to the at least one wireless device 831, 832, 833 in the first group 830 of wireless devices 831, 832, 833, or the at least second wireless device 831, 832, 833.

Action 903

The network node 810 sends a single message to the first group 830 of wireless devices 831, 832, 833. The wireless devices 831, 832, 833 in the first group 830 of wireless devices 831, 832, 833 are in CA mode, being further served by the Secondary Cell, SCell, 822 of the network node 810. The single message comprises a first common Radio Network Temporary Identifier, RNTI, addressing all the wireless devices 831, 832, 833 in the first group 830 of wireless devices 831, 832, 833. The single message further comprises information related to the SCell 822.

For example, in some embodiments, the information related to the SCell 822 is Multimedia Broadcast and Multicast Service, MBMS, subframe information.

In some embodiments, the second group 840 of wireless devices 841, 842, 843 operates in the wireless communications network 800. The second group 840 of wireless devices 841, 842, 843 may comprise at least a first wireless device 841, 831 in the first group 830 of wireless devices 831, 832, 833. In some of these embodiments, the single message may further comprise a second common RNTI, addressing all the wireless devices 841, 842, 843 in the second group 840 of wireless devices 841, 842, 843. In these embodiments, the single message, by comprising the first common RNTI and the second common RNTI, addresses the at least first wireless device 831, 841 in the first group 830 of wireless devices 831, 832, 833 that is comprised in the second group 840 of wireless devices 841, 842, 843.

In some embodiments, the first common RNTI value is a CA-RNTI, and the second common RNTI value is a D-RNTI.

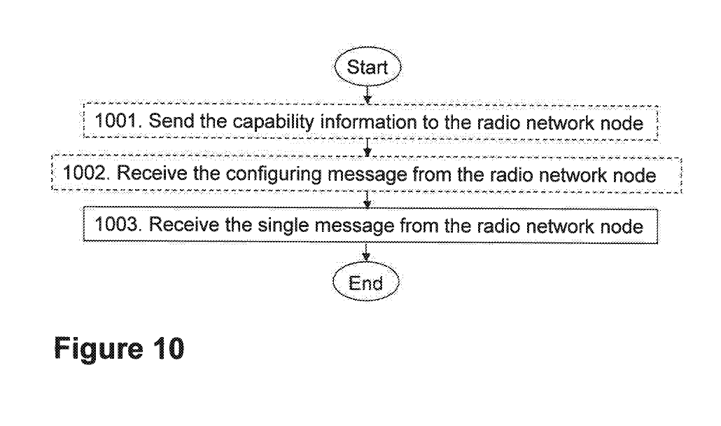

Embodiments of a method performed by the wireless device 831 in the first group 830 of wireless devices 831, 832, 833 for receiving the message from the network node 810, will now be described with reference to the flowchart depicted in FIG. 10. As stated earlier, the first group 830 of wireless devices 831, 832, 833 is served by the PCell 821 of the network node 810. Also as stated earlier, the network node 810, wireless device 831, and the first group 830 of wireless devices 831, 832, 833 operate in the wireless communications network 800. FIG. 10 depicts a flowchart of the actions that are or may be performed by the wireless device 831 in embodiments herein. Discontinued lines depict optional actions. A continuous line depicts a mandatory action.

The method may comprise the following actions, which actions may as well be carried out in another suitable order than that described below. In some embodiments, all the actions may be carried out, whereas in other embodiments only some action/s may be carried out.

Action 1001

The wireless device 831 may send the capability information of the wireless device 831 to the network node 810, the capability information comprising the at least one of: the capability to be in CA mode and the capability to process CA-RNTI information.

In some embodiments, this may be implemented by sending the UECapabilitylnformation message to the network node 810.

This is an optional action.

Action 1002

The wireless device 831 may receive the configuring message from the network node 810 to be in CA mode.

In some embodiments, this may be implemented by receiving the RRCConnectionReconfiguration message from the network node 810.

This is an optional action.

Action 1003

The wireless device 831 receives the single message from the network node 810. The single message is addressed to the first group 830 of wireless devices 831, 832, 833. The wireless device 831 and the wireless devices 831, 832, 833 in the first group 830 of wireless devices 831, 832, 833 are in CA mode, being further served by the SCell 822 of the network node 810. The single message comprises the first common RNTI, addressing all the wireless devices 831, 832, 833 in the first group 830 of wireless devices 831, 832, 833. The single message further comprises the information related to the SCell 822.

In some embodiments, the second group 840 of wireless devices 841, 842, 843, operates in the wireless communications network 800. In these embodiments, the wireless device 831, 841 is the at least first wireless device 831 in the first group 830 of wireless devices 831, 832, 833 that is comprised in the second group 840 of wireless devices 841, 842, 843. In these embodiments, the single message further comprises the second common RNTI, addressing all the wireless devices 841, 842, 843 in the second group 840 of wireless devices 841, 842, 843. In these embodiments, the single message, by comprising the first common RNTI and the second common RNTI, addresses the at least first wireless device 831, 841 in the first group 830 of wireless devices 831, 832, 833 that is comprised in the second group 840 of wireless devices 841, 842, 843.

In some embodiments, the information related to the SCell 822 is the MBMS subframe information.

In some embodiments, the first common RNTI value is the CA-RNTI, and the second common RNTI value is the D-RNTI.

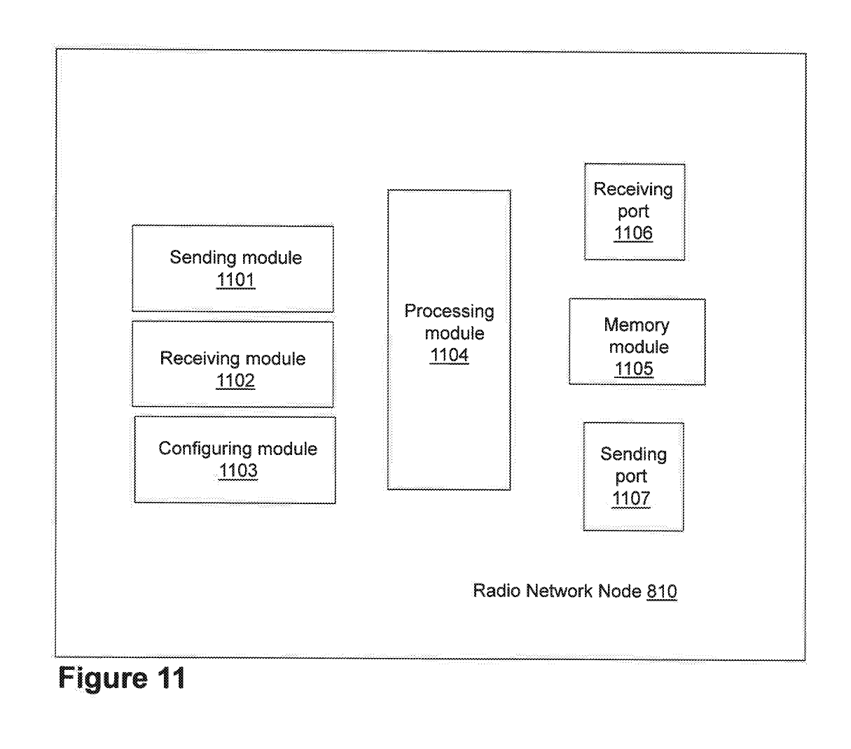

To perform the method actions described above in relation to FIG. 9, for sending the message to the first group 830 of wireless devices 831, 832, 833, the network node 810 comprises the following arrangement depicted in FIG. 11. As stated earlier, the first group 830 of wireless devices 831, 832, 833 is configured to be served by the PCell, 821 of the network node 810. As also stated earlier, the network node 810 and the first group 830 of wireless devices 831, 832, 833 are configured to operate in the wireless communications network 800. The detailed description of some of the following corresponds to the same references provided above, in relation to the actions described for the network node 810, and will thus not be repeated here.

The network node 810 is configured to send the single message to the first group 830 of wireless devices 831, 832, 833, wherein the wireless devices 831, 832, 833 in the first group 830 of wireless devices 831, 832, 833 are configured to be in CA mode, wherein the single message comprises the first common RNTI, configured to address all the wireless devices 831, 832, 833 in the first group 830 of wireless devices 831, 832, 833, and wherein the single message further comprises information related to the SCell.

In some embodiments, this may be implemented by a sending module 1101, as described below, for sending the single message to the first group 830 of wireless devices 831, 832, 833, wherein the wireless devices 831, 832, 833 in the first group 830 of wireless devices 831, 832, 833 are configured to be in CA mode, being further served by the SCell 822 of the network node 810, wherein the single message comprises the first common RNTI, configured to address all the wireless devices 831, 832, 833 in the first group 830 of wireless devices 831, 832, 833, and wherein the single message further comprises information related to the SCell.

In some embodiments, the second group 840 of wireless devices 841, 842, 843 is configured to operate in the wireless communications network 800. The second group 840 of wireless devices 841, 842, 843 comprises the at least first wireless device 841, 831 in the first group 830 of wireless devices 831, 832, 833. In these embodiments, the single message further comprises the second common RNTI, configured to address all the wireless devices 841, 842, 843 in the second group 840 of wireless devices 841, 842, 843, and the single message is configured to address the at least first wireless device 831, 841 in the first group 830 of wireless devices 831, 832, 833 that is comprised in the second group 840 of wireless devices 841, 842, 843.

In some embodiments, the information related to the SCell 822 is the MBMS subframe information.

In some embodiments, the first common RNTI value is the CA-RNTI, and the second common RNTI value is the D-RNTI.

In some embodiments, the network node 810 is further configured to receive, from at least the second wireless device 831, 832, 833 in the first group 830 of wireless devices 831, 832, 833, the capability information of the at least second wireless device 831, 832, 833, the capability information comprising at least one of: capability to be in CA mode and capability to process CA-RNTI information.

In some embodiments, this may be implemented by a receiving module 1102, as described below for receiving, from at least the second wireless device 831, 832, 833 in the first group 830 of wireless devices 831, 832, 833, the capability information of the at least second wireless device 831, 832, 833, the capability information comprising the at least one of: capability to be in CA mode and capability to process CA-RNTI information.

In some embodiments, the network node 810 is further configured to configure the at least second wireless device 831, 832, 833 in the first group 830 of wireless devices 831, 832, 833 to be in CA mode.

In some embodiments, this may be implemented by a configuring module 1103, as described below, for configuring the at least second wireless device 831, 832, 833 in the first group 830 of wireless devices 831, 832, 833 to be in CA mode.

The embodiments herein for sending the message to the first group 830 of wireless devices 831, 832, 833 may be implemented through one or more processors, such as the processing module 1104 in the network node 810 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the network node 810. One such carrier may be in the form of a CD ROM disc. It may be however feasible with other data carriers such as a memory stick. The computer program code may furthermore be provided as pure program code on a server and downloaded to the network node 810.

The network node 810 may further comprise a memory module 1105 comprising one or more memory units. The memory module 1105 may be arranged to be used to store data in relation to applications to perform the methods herein when being executed in the network node 810. Memory module 1105 may be in communication with the processing module 1104. Any of the other information processed by the processing module 1104 may also be stored in the memory module 1105.

In some embodiments, information from e.g., the wireless device 831, may be received through a receiving port 1106. In some embodiments, the receiving port 1106 may be, for example, connected to the one or more antennas in the network node 810. In other embodiments, the network node 810 may receive information from another structure in the wireless communications network 800 through the receiving port 1106. Since the receiving port 1106 may be in communication with the processing module 1104, the receiving port 1106 may then send the received information to the processing module 1104. The receiving port 1106 may also be configured to receive other information.

The information processed by the processing module 1104 in relation to the embodiments of the method herein may be stored in the memory module 1105 which, as stated earlier, may be in communication with the processing module 1104 and the receiving port 1106.

The processing module 1104 may be further configured to transmit or send information to the wireless device 831 or another node in the wireless communications network 800, through a sending port 1107, which may be in communication with the processing module 1104, and the memory module 1105.

Those skilled in the art will also appreciate that the sending module 1101, the receiving module 1102, and the configuring module 1103 described above may refer to a combination of analog and digital circuits, and/or one or more processors configured with software and/or firmware, e.g., stored in memory, that, when executed by the one or more processors such as the processing module 1104, perform as described above. One or more of these processors, as well as the other digital hardware, may be included in a single Application-Specific Integrated Circuit (ASIC), or several processors and various digital hardware may be distributed among several separate components, whether individually packaged or assembled into a System-On-a-Chip (SoC).

Also, in some embodiments, the sending module 1101, the receiving module 1102, and the configuring module 1103 may be implemented as one or more applications running on one or more processors such as the processing module 1104.

Thus, the methods according to the embodiments described herein for the network node 810 are respectively implemented by means of a computer program product, comprising instructions, i.e., software code portions, which, when executed on at least one processor, cause the at least one processor to carry out the actions described herein, as performed by the network node 810. The computer program product may be stored on a computer-readable storage medium. The computer-readable storage medium, having stored thereon the computer program, may comprise instructions which, when executed on at least one processor, cause the at least one processor to carry out the actions described herein, as performed by the network node 810. In some embodiments, the computer-readable storage medium may be a non-transitory computer-readable storage medium.

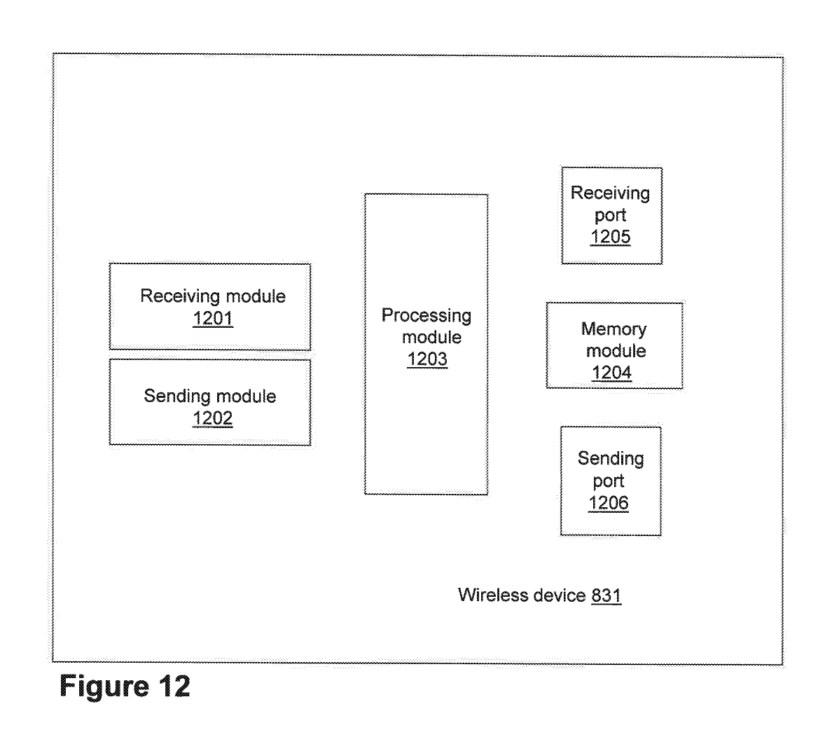

To perform the method actions described above in relation to FIG. 10 for receiving the message from the network node 810, the wireless device 831 comprises the following arrangement depicted in FIG. 12. The wireless device 831 is configured to be comprised in the first group 830 of wireless devices 831, 832, 833. The first group 830 of wireless devices 831, 832, 833 is served by the PCell 821 of the network node 810. The network node 810, wireless device 831, and the first group 830 of wireless devices 831, 832, 833 are configured to operate in the wireless communications network 800. The detailed description of some of the following corresponds to the same references provided above, in relation to the actions described for the wireless device 831, and will thus not be repeated here.

The wireless device 831 is configured to receive the single message from the network node 810. The single message is configured to address the first group 830 of wireless devices 831, 832, 833. The wireless device 831 and the wireless devices 831, 832, 833 in the first group 830 of wireless devices 831, 832, 833 are configured to be in CA mode, being further served by the SCell 822 of the network node 810. The single message comprises the first common RNTI, configured to address all the wireless devices 831, 832, 833 in the first group 830 of wireless devices 831, 832, 833, and the single message further comprises information related to the SCell 822.

In some embodiments, this may be implemented by a receiving module 1201, as described below, for receiving the single message from the network node 810. The single message is configured to address the first group 830 of wireless devices 831, 832, 833. The wireless device 831 and the wireless devices 831, 832, 833 in the first group 830 of wireless devices 831, 832, 833 are configured to be in CA mode. The single message comprises the first common RNTI, configured to address all the wireless devices 831, 832, 833 in the first group 830 of wireless devices 831, 832, 833, and the single message further comprises information related to the SCell 822.

In some embodiments, the second group 840 of wireless devices 841, 842, 843 is configured to operate in the wireless communications network 800. In these embodiments, the wireless device 831, 841 is the at least first wireless device 831 in the first group 830 of wireless devices 831, 832, 833 that is comprised in the second group 840 of wireless devices 841, 842, 843. In these embodiments, the single message further comprises the second common RNTI, configured to address all the wireless devices 841, 842, 843 in the second group 840 of wireless devices 841, 842, 843, and the single message addresses the at least first wireless device 831, 841 in the first group 830 of wireless devices 831, 832, 833 that is comprised in the second group 840 of wireless devices 841, 842, 843.

In some embodiments, the information related to the SCell 822 is MBMS, subframe information.

In some embodiments, the first common RNTI value is the CA-RNTI, and the second common RNTI value is the D-RNTI.

In some embodiments, the wireless device 831 is further configured to send the capability information of the wireless device 831 to the network node 810, the capability information comprising at least one of: capability to be in CA mode and capability to process CA-RNTI information.

In some embodiments, this may be implemented by a sending module 1202, as described below, for sending the capability information of the wireless device 831 to the network node 810, the capability information comprising at least one of: capability to be in CA mode and capability to process CA-RNTI information.

In some embodiments, the wireless device 831 is further configured to receive the configuring message from the network node 810 to be in CA mode.

In some embodiments, this may be implemented by the receiving module 1201 further being for receiving the configuring message from the network node 810 to be in CA mode.

The embodiments herein for receiving the message from the network node 810 may be implemented through one or more processors, such as the processing module 1203 in the wireless device 831 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the wireless device 831. One such carrier may be in the form of a CD ROM disc. It may be however feasible with other data carriers such as a memory stick. The computer program code may furthermore be provided as pure program code on a server and downloaded to the wireless device 831.

The wireless device 831 may further comprise a memory module 1204 comprising one or more memory units. The memory module 1204 may be arranged to be used to store data in relation to applications to perform the methods herein when being executed in the wireless device 831. Memory module 1204 may be in communication with the processing module 1203. Any of the other information processed by the processing module 1203 may also be stored in the memory module 1204.

In some embodiments, information from, e.g., the network node 810, may be received through a receiving port 1205. In some embodiments, the receiving port 1205 may be, for example, connected to the one or more antennas in the wireless device 831. In other embodiments, the wireless device 831 may receive information from another structure in the wireless communications network 800 through the receiving port 1205. Since the receiving port 1205 may be in communication with the processing module 1203, the receiving port 1205 may then send the received information to the processing module 1203. The receiving port 1205 may also be configured to receive other information.

The information processed by the processing module 1203 in relation to the embodiments of method herein may be stored in the memory module 1204 which, as stated earlier, may be in communication with the processing module 1203 and the receiving port 1205.

The processing module 1203 may be further configured to transmit or send information to, e.g., the network node 810, through a sending port 1206, which may be in communication with the processing module 1203, and the memory module 1204.

Those skilled in the art will also appreciate that the receiving module 1201 and the sending module 1202 described above may refer to a combination of analog and digital circuits, and/or one or more processors configured with software and/or firmware, e.g., stored in memory, that, when executed by the one or more processors such as the processing module 1203, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Also, in some embodiments, the receiving module 1201, and the sending module 1201 may be implemented as one or more applications running on one or more processors such as the processing module 1203.

Thus, the methods according to the embodiments described herein for the wireless device 831 are respectively implemented by means of a computer program product, comprising instructions, i.e., software code portions, which, when executed on at least one processor, cause the at least one processor to carry out the actions described herein, as performed by the wireless device 831. The computer program product may be stored on a computer-readable storage medium. The computer-readable storage medium, having stored thereon the computer program, may comprise instructions which, when executed on at least one processor, cause the at least one processor to carry out the actions described herein, as performed by the wireless device 831. In some embodiments, the computer-readable storage medium may be a non-transitory computer-readable storage medium.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

1. A method in a network node for sending a message to a first group of wireless devices, the first group of wireless devices being served by a Primary Cell, PCell, of the network node, the network node and the first group of wireless devices operating in a wireless communications network, and the method comprising:
sending a single message to the first group of wireless devices, wherein the wireless devices in the first group of wireless devices are in carrier aggregation mode, being further served by a Secondary Cell, SCell, of the network node, wherein the single message comprises a first common Radio Network Temporary Identifier, RNTI, addressing all the wireless devices in the first group of wireless devices, and wherein the single message further comprises information related to the SCell.

2. The method of claim 1, wherein a second group of wireless devices operates in the wireless communications network, which second group of wireless devices comprises at least a first wireless device in the first group of wireless devices, and wherein the single message further comprises a second common RNTI, addressing all the wireless devices in the second group of wireless devices, and wherein the single message addresses the at least first wireless device in the first group of wireless devices that is comprised in the second group of wireless devices.

3. The method of claim 1, wherein the information related to the SCell is Multimedia Broadcast and Multicast Service, MBMS, subframe information.

4. The method of claim 1, further comprising, receiving, from at least a second wireless device in the first group of wireless devices, capability information of the at least second wireless device, the capability information comprising at least one of: capability to be in carrier aggregation mode and capability to process CA-RNTI information.

5. The method of claim 1, further comprising, configuring the at least second wireless device in the first group of wireless devices to be in carrier aggregation mode.

6. The method of claim 2, wherein the first common RNTI value is a CA-RNTI, and the second common RNTI value is a D-RNTI.

7. A computer program, comprising instructions which, when executed on at least one processor, cause the at least one processor to carry out the method according to claim 1.

8. A non-transitory computer-readable storage medium, having stored thereon a computer program, comprising instructions which, when executed on at least one processor, cause the at least one processor to carry out the method according to claim 1.

9. A method in a wireless device in a first group of wireless devices for receiving a message from a network node, the first group of wireless devices being served by a Primary Cell, PCell, network node, wireless device, and the first group of wireless devices operating in a wireless communications network, and the method comprising:
receiving a single message from the network node, the single message being addressed to the first group of wireless devices, wherein the wireless device and the wireless devices in the first group of wireless devices are in carrier aggregation mode, being further served by a Secondary Cell, SCell, of the network node, wherein the single message comprises a first common Radio Network Temporary Identifier, RNTI, addressing all the wireless devices in the first group of wireless devices, and wherein the single message further comprises information related to the SCell.

10. The method of claim 9, wherein a second group of wireless devices operates in the wireless communications network, wherein the wireless device is at least a first wireless device in the first group of wireless devices that is comprised in the second group of wireless devices, and wherein the single message further comprises a second common RNTI, addressing all the wireless devices in the second group of wireless devices, and wherein the single message addresses the at least first wireless device in the first group of wireless devices that is comprised in the second group of wireless devices.

11. The method of claim 9, wherein the information related to the SCell is Multimedia Broadcast and Multicast Service, MBMS, subframe information.

12. The method of claim 9, further comprising, sending, capability information of the wireless device to the network node, the capability information comprising at least one of: capability to be in carrier aggregation mode and capability to process CA-RNTI information.

13. The method of claim 9, further comprising, receiving a configuring message from the network node to be in carrier aggregation mode.

14. The method of claim 9, wherein the first common RNTI value is a CA-RNTI, and the second common RNTI value is a D-RNTI.

15. A computer program, comprising instructions which, when executed on at least one processor, cause the at least one processor to carry out the method according to claim 9.

16. A non-transitory computer-readable storage medium, having stored thereon a computer program, comprising instructions which, when executed on at least one processor, cause the at least one processor to carry out the method according to claim 9.

17. A network node for sending a message to a first group of wireless devices, the first group of wireless devices being configured to be served by a Primary Cell, PCell, the network node and the first group of wireless devices being configured to operate in a wireless communications network, the network node being configured to:
send a single message to the first group of wireless devices, wherein the wireless devices in the first group of wireless devices are configured to be in carrier aggregation mode, to be further served by a Secondary Cell, SCell, of the network node, wherein the single message comprises a first common Radio Network Temporary Identifier, RNTI, configured to address all the wireless devices in the first group of wireless devices, and wherein the single message further comprises information related to the SCell.

18. The network node of claim 17, wherein a second of wireless devices is configured to operate in the wireless communications network, which second group of wireless devices comprises at least a first wireless device in the first group of wireless devices, and wherein the single message further comprises a second common RNTI, configured to address all the wireless devices in the second group of wireless devices, and wherein the single message is configured to address the at least first wireless device in the first group of wireless devices that is comprised in the second group of wireless devices.

19. The network node of claim 17, wherein the information related to the SCell is Multimedia Broadcast and Multicast Service, MBMS, subframe information.

20. The network node of claim 17, the network node being further configured to receive, from at least a second wireless device in the first group of wireless devices, capability information of the at least second wireless device, the capability information comprising at least one of: capability to be in carrier aggregation mode and capability to process CA-RNTI information.

21. The network node of claim 17, the network node being further configured to configure the at least second wireless device in the first group of wireless devices to be in carrier aggregation mode.

22. The network node of claim 18, wherein the first common RNTI value is a CA-RNTI, and the second common RNTI value is a D-RNTI.

23. A wireless device for receiving a message from a network node, the wireless device being configured to be in a first group of wireless devices, the first group of wireless devices being configured to be served by a Primary Cell, PCell, of the network node, the network node, wireless device, and the first group of wireless devices being configured to operate in a wireless communications network, the wireless device being configured to:
receive a single message from the network node, the single message being configured to address the first group of wireless devices, wherein the wireless device and the wireless devices in the first group of wireless devices are configured to be in carrier aggregation mode, to be further served by a Secondary Cell, SCell, of the network node, wherein the single message comprises a first common Radio Network Temporary Identifier, RNTI, configured to address all the wireless devices in the first group of wireless devices, and wherein the single message further comprises information related to the SCell.

24. The wireless device of claim 23, wherein a second group of wireless devices is configured to operate in the wireless communications network, wherein the wireless device is at least a first wireless device in the first group of wireless devices that is comprised in the second group of wireless devices, and wherein the single message further comprises a second common RNTI, configured to address all the wireless devices in the second group of wireless devices, and wherein the single message addresses the at least first wireless device in the first group of wireless devices that is comprised in the second group of wireless devices.

25. The wireless device of claim 23, wherein the information related to the SCell is Multimedia Broadcast and Multicast Service, MBMS, subframe information.

26. The wireless device of claim 23, the wireless device being further configured to send capability information of the wireless device to the network node, the capability information comprising at least one of: capability to be in carrier aggregation mode and capability to process CA-RNTI information.

27. The wireless device of claim 23, the wireless device being further configured to receive a configuring message from the network node to be in carrier aggregation mode.

28. The wireless device of claim 24, wherein the first common RNTI value is a CA-RNTI, and the second common RNTI value is a D-RNTI.
